(19) United States
(12) Patent Application Publication
(10) Pub. No.: US 2016/0184922 A1
(43) Pub. Date: Jun. 30, 2016

(54) FRICTION POINT JOINING DEVICE AND FRICTION POINT JOINING METHOD

(71) Applicant: TOYOTA JIDOSHA KABUSHIKI KAISHA, Toyota-shi (JP)

(72) Inventor: Chiaki KIKYO, Toyota-shi (JP)

(73) Assignee: TOYOTA JIDOSHA KABUSHIKI KAISHA, Toyota-shi (JP)

(21) Appl. No.: 14/976,394

(22) Filed: Dec. 21, 2015

(30) Foreign Application Priority Data
Dec. 26, 2014 (JP) 2014-266225

(51) Int. Cl. B23K 20/227; B23K 20/12

(52) U.S. Cl. CPC B23K 20/2275; B23K 20/1235; B23K 20/125; B23K 2203/04

(57) ABSTRACT

A friction point joining device has a rotary tool, a servo motor, a tool temperature measuring instrument, a material temperature measuring instrument, and a feedback device. The rotary tool abuts against the aluminum material side of a stacking body of the aluminum material and the galvanized steel sheet. The servo motor causes the rotary tool to rotate. The tool temperature measuring instrument measures a temperature of the rotary tool. The material temperature measuring instrument measures a temperature of a joint section between the aluminum material and the galvanized steel sheet. The feedback device is configured to execute feedback control of the servo motor on the basis of temperature information obtained from the tool temperature measuring instrument and the material temperature measuring instrument.

### INCORPORATION BY REFERENCE

The disclosure of Japanese Patent Application No. 2014-266225 filed on Dec. 26, 2014 including the specification, drawings and abstract is incorporated herein by reference in its entirety.

### BACKGROUND OF THE INVENTION

1. Field of the Invention

The invention relates to a friction point joining device and a friction point joining method for joining an aluminum material and a galvanized steel sheet at a friction point.

2. Description of Related Art

Friction point joining has been performed by locally generating a friction heat in a stacking body of an aluminum material and a steel sheet by using a rotary tool so as to cause plastic flow in the material. In the case where a temperature at which the plastic flow of the material occurs is high (1000 to 1200° C. in a case of the steel sheet, for example) in the friction point joining, a metal oxide compound is generated on a joint boundary surface. The metal oxide compound is extremely brittle due to a material characteristic thereof. Thus, when the metal oxide compound is present on the joint boundary surface, joint strength is extremely lowered.

A machining condition for not generating the metal oxide compound and a machining condition for suppressing generation of the metal oxide compound to be extremely thin (10 μm or thinner) so as not to affect the strength even when being generated are available. However, elaborate control is required in terms of a positional relationship between the rotary tool and the joint boundary surface, and the like. Therefore, a device for mass production of parts that is operated under such conditions has not actually been in practical use.

Japanese Patent Application Publication No. 2009-106998 (JP 2009-106998 A) describes, as a friction point joining method through which high joint strength is obtained, a method for joining the aluminum material and the steel sheet at a friction point, that is, a method in which an alloying treatment is performed to form a Zn—Fe alloy plated layer after a joint surface side of a steel member is galvanized, an aluminum member is stacked on the Zn—Fe alloy plated layer after a surface of the Zn—Fe alloy plated layer is smoothed by laser heating, the aluminum member is pressed at a joint section while the rotary tool is rotated, and the joint section between the aluminum member and the steel member is joined at a point. It is also described that, in this method, Zn in the Zn—Fe alloy plated layer is diffused in the aluminum member to form a Zn diffusion layer, Al in the aluminum member is diffused in the Zn—Fe alloy plated layer to form an Al—Fe intermediate layer, the joint section between the aluminum member and the steel member is joined at the point via this intermediate layer, thus the joint strength is intensified, and a joining time can be shortened.

### SUMMARY OF THE INVENTION

In the friction point joining method described in JP 2009-106998 A, the Al—Fe intermediate layer is formed on the joint boundary surface between the aluminum material and the steel sheet, so as to obtain the high joint strength. It is expected that control accuracy for controlling the positional relationship between the rotary tool and the joint boundary surface is alleviated to some extent. However, the processing for forming the Zn—Fe alloy plated layer and the processing for melting and smoothing the surface thereof by the laser heating are required in a process of the processing. As a result, complication of the device and cost increase caused by the above processing cannot be avoided.

The invention provides a friction point joining device and a friction point joining method that can simplify the device.

According to an aspect of the invention, a friction point joining device joins an aluminum material and a galvanized steel sheet. The friction point joining device has a rotary tool, a servo motor, a tool temperature measuring instrument, a material temperature measuring instrument, and a feedback device. The rotary tool abuts against the aluminum material side of a stacking body of the aluminum material and the galvanized steel sheet. The servo motor causes the rotary tool to rotate. The tool temperature measuring instrument measures a temperature of the rotary tool. The material temperature measuring instrument measures a temperature of a joint section between the aluminum material and the galvanized steel sheet. The feedback device is configured to execute feedback control of the servo motor on the basis of temperature information obtained from the tool temperature measuring instrument and the material temperature measuring instrument.

Because the friction point joining device according to the aspect of the invention includes the feedback device that executes feedback control of the servo motor on the basis of the temperature information of the joint section of the stacking body and the temperature information of the rotary tool, a distance between a tip of the rotary tool and the joint section between the aluminum material and the galvanized steel sheet can be controlled to be set within a required range, and the temperature of the joint section can be controlled to be set within a required temperature range. A friction point joint product with high joint strength can be obtained by joining the aluminum material and the galvanized steel sheet at a friction point by using the friction point joining device according to the aspect of the invention. As targets of the feedback control, a rotational speed of the servo motor, an applied pressure, a machining time, and the like are raised.

In the above aspect, the friction point joining device may be configured to control the servo motor such that the temperature of the joint section become 320 to 350° C.

According to the above aspect, a heat input amount is able to be set such that the temperature of the joint section becomes 320 to 350° C., and processing is performed at such a rotational speed of the servo motor, an applied pressure, and a machining time that the set heat input amount is obtained. Meanwhile, the temperature of the joint section cannot directly be measured. However, due to a high heat transfer coefficient of an aluminum sheet, it is estimated whether the temperature of the joint section reaches a target temperature by measuring temperatures of a position where the rotary tool comes into contact with the aluminum sheet and of a position in the vicinity of the position. In the case where the measured temperature is too high or low with respect to the target temperature, the feedback control is executed, and various conditions are changed such that the temperature of the joint section becomes the target temperature.

Another aspect of the invention relates to a friction point joining method of a friction point joining device for joining an aluminum material and a galvanized steel sheet at a friction point. The friction point joining device includes a rotary tool. The rotary tool abuts against the aluminum material side of a stacking body of the aluminum material and the galvanized steel sheet. The friction point joining method includes forming a new surface in a joint section between the aluminum material and the galvanized steel sheet by setting a temperature of the joint section to be within a range of 320° C. to 350° C. by frictional heat that is associated with rotation of the rotary tool and performing friction point joining while generating an intermetallic compound of Fe and Al in the joint section.

In the above aspect, the friction point joining may be performed in such a state that a distance between a surface of the galvanized steel sheet in the joint section and a tip of the rotary tool is maintained to be within a range of 0.1 mm to 0.3 mm on the aluminum material side.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view for illustrating a friction point joining device according to the invention;

FIG. 2 is a view (photograph) of an EPMA analysis result for showing a state where a galvanized layer of a galvanized steel sheet is melted, is liquefied, and flows;

FIG. 3 is a view (photograph) of the EPMA analysis result for showing a state where an oxide film on a base material surface is damaged and the oxide layer is diffused;

FIG. 4 is a view (photograph) of the EPMA analysis result of a joint boundary surface;

FIG. 5 is a view (photograph) of the EPMA analysis result in the case where a machining condition is changed, and here, the galvanized layer is not melted; and

FIG. 6 is a view (photograph) of the EPMA analysis result in the case where the machining condition is changed, and here, the oxide layer remains on the joint boundary surface.

### DETAILED DESCRIPTION OF EMBODIMENTS

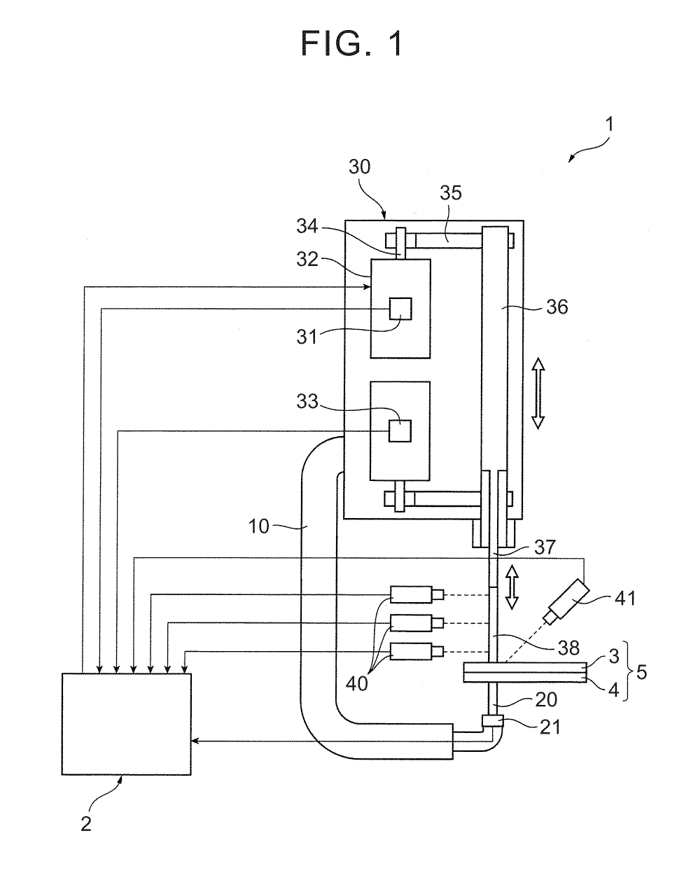

The invention will hereinafter be described in further detail on the basis of an embodiment. FIG. 1 shows one example of a friction point joining device according to the invention.

A friction point joining device 1, which is shown, is equipped at a tip section of a robot arm, such as a 6-axis vertical articulated robot, which is not shown, and further includes a control section 2. The friction point joining device 1 has an arm 10, and a receiver 20 and a drive section 30 are respectively attached to a lower end side and an upper end side of the arm 10. A load cell 21 is installed in a position between the receiver 20 and the arm 10. An actual applied pressure that acts on the receiver 20 is measured by the load cell 21, and a measurement value is sent to the control section 2. To perform friction point joining, a stacking body 5 of an aluminum material 3 and a galvanized steel sheet 4 to be subjected to the friction point joining is arranged on an upper end side of the receiver 20 with the galvanized steel sheet 4 side being the receiver 20 side.

The drive section 30 has: a pressurizing servo motor 32 that includes an encoder 31; and a machining time measuring timer 33. As the pressurizing servo motor 32, a servo motor that can control by a unit of 0.01 mm is used. A rotary shaft 34 of the pressurizing servo motor 32 is coupled to a rotary tool drive shaft 36 for driving via an appropriate power transmission mechanism 35. The rotary tool drive shaft 36 is equipped with an actuation shaft 37 therein, the actuation shaft 37 vertically moving while rotating in response to forward/reverse rotation of the pressurizing servo motor 32. In response to the rotation of the pressurizing servo motor 32, the actuation shaft 37 repeats descending movement along with rotation in one direction and ascending movement along with rotation in a reverse direction.

The rotary tool drive shaft 36 and the actuation shaft 37 are attached to a position that opposes the receiver 20 such that center axes thereof coincide with a center axis of the receiver 20 and that a specified distance is secured between a lower end of the actuation shaft 37 and the upper end of the receiver 20. In addition, a rotary tool 38 is detachably connected to the lower end of the actuation shaft 37 via appropriate coupling means.

A rotation time of the actuation shaft 37 is measured by the machining time measuring timer 33, and a measurement value is sent to the control section 2. In addition, a machining distance of the actuation shaft 37 during machining, that is, a moving distance (push-in amount) of the rotary tool 38 is monitored by the encoder 31, and positional information of the encoder 31 is sent to the control section 2.

The friction point joining device 1 further has a tool temperature measuring function, for which the appropriate number of non-contact tool temperature measuring instruments 40 for measuring a temperature of the rotary tool 38 attached to the actuation shaft 37, such as laser-type radiation temperature sensors, are provided. In an illustrated example, the three tool temperature measuring instruments 40 are provided at almost equal intervals along an axial line of the rotary tool 38, so as to be able to measure temperatures of three positions of an upper section, an intermediate section, and a tip section (lower end section) of the rotary tool 38. Temperature information of each of the tool temperature measuring instruments 40 is sent to the control section 2. It should be noted that the number of the tool temperature measuring instrument 40 may be one, may be two, or may be four or more.

The friction point joining device 1 further includes a non-contact material temperature measuring instrument 41, such as the laser-type radiation temperature sensor. The material temperature measuring instrument 41 is used to measure a temperature of a joint section between the aluminum material 3 and the galvanized steel sheet 4 and is actually arranged in a position where the material temperature measuring instrument 41 can measure a temperature of the material in a position where the tip of the rotary tool 38 comes into contact with the aluminum material 3 or a position in the vicinity of the position. Temperature information of the material temperature measuring instrument 41 is sent to the control section 2.

The control section 2 is a device that has a function of receiving signals from the load cell 21, the encoder 31, the machining time measuring timer 33, the tool temperature measuring instruments 40, and the material temperature measuring instrument 41, which are described above, and calculating and outputting a required correction value. The calculated correction value is fed back to the pressurizing servo motor 32, and position control of the rotary tool 38 is executed. It should be noted that the control section itself that has such a feedback function and can execute the position control of a control target by feedback information can be a conventionally known control section and thus a detailed description of the control section 2 will not be made.

Next, actuation of the above friction point joining device 1 will be described. At a start of friction point joining processing, the 6-axis vertical articulated robot, which is not shown, moves the friction point joining device 1 to a position where the friction point joining will be performed in the stacking body 5 of the aluminum material 3 and the galvanized steel sheet 4. The friction point joining device 1 has a posture of holding the stacking body 5 between the receiver 20 and the rotary tool 38 such that the rotary tool 38 is positioned on the aluminum material 3 side.

The control section 2 actuates the pressurizing servo motor 32 to drive the rotary tool drive shaft 36 and applies the forward rotation to the actuation shaft 37 thereof. In this way, the actuation shaft 37 descends toward the aluminum material 3, the rotary tool 38 that is attached to the tip thereof also descends while rotating synchronously, and the tip of the rotary tool 38 abuts against the aluminum material 3. This movement is monitored by the encoder 31.

When the rotary tool 38 further descends while rotating, an area near a portion of the stacking body 5, with which the tip of the rotary tool 38 is in contact, is gradually pressurized and heated. The arm 10 is deflected due to pressurization. Thus, this deflection has to be corrected for the accurate position control. For this reason, the friction point joining device 1 includes in advance a deflection correction chart in which a deflection amount of the arm 10 with respect to the applied pressure is experimentally computed. During the processing, a signal related to the applied pressure is sent to the control section 2 from the load cell 21 that is arranged between the receiver 20 and the arm 10. The control section 2 puts the actual applied pressure to the deflection correction chart and feeds back the deflection amount to the pressurizing servo motor 32 side. Accordingly, the rotary tool 38 is controlled to be further pushed in by this amount.

When the rotary tool 38 descends while pressurizing the stacking body 5 of the aluminum material 3 and the galvanized steel sheet 4, the rotary tool 38 itself is also heated by frictional heat with the stacking body 5 and is expanded by heat. Correction also has to be made for this heat expansion for the accurate position control. For this correction, temperature signals of the three vertical positions of the rotary tool 38, which are measured by the tool temperature measuring instruments 40 described above, are sent to the control section 2. The control section 2 applies a linear expansion coefficient to each of the temperatures of the three positions to calculate extension of the rotary tool 38, feeds back the extension of the rotary tool 38 to the pressurizing servo motor 32 side, and is actuated to subtract an extension amount from the push-in amount.

By executing the position control as described above, the friction point joining device 1 can set an insertion position of the tip of the rotary tool 38 with accuracy of ±0.1 mm. In addition, in the actual friction point joining processing, the position of the tip of the rotary tool 38 is preferably controlled to be set within a range of 0.1 to 0.3 mm on the aluminum material 3 side from a boundary surface between the aluminum material 3 and the galvanized steel sheet 4 of the stacking body 5.

In the case where the tip of the rotary tool 38 accidentally reaches a surface of the galvanized steel sheet 4 of the stacking body 5, it results in product failure. In order to avoid this, the friction point joining device 1 preferably has an emergency stop function. This emergency stop function uses such a phenomenon that a load is abruptly increased at a moment the tip of the rotary tool 38 comes into contact with the galvanized steel sheet 4, and has a function of stopping the friction point joining device 1 by using a measurement value of the load cell 21 at the time.

In order for the friction point joining device 1 and a friction point joining method according to the invention to achieve a desired purpose, control for setting such a temperature that a galvanized layer of the galvanized steel sheet 4 is melted and the aluminum material 3 moderately and plastically flows (it should be noted that this temperature is known to be 320° C. to 350° C. from an experiment by the inventors) has to be executed. For this purpose, the friction point joining device 1 has a material temperature monitoring function for which the material temperature measuring instrument 41 is provided. A material temperature, that is, a temperature of a position in the stacking body 5 of the aluminum material 3 and the galvanized steel sheet 4 that is in contact with the tip of the rotary tool 38 is changed by quality of the material, a shape of the tip of the rotary tool 38, and a machining condition. Accordingly, the control section 2 receives a temperature signal from the material temperature measuring instrument 41 and constantly monitors the temperature of the joint section between the aluminum material 3 and the galvanized steel sheet 4 (that substantially corresponds to the temperature of the position in the stacking body 5 that is in contact with the tip of the rotary tool 38). Then, in the case where it is determined that a temperature increase is insufficient, the control section 2 controls the machining time measuring timer 33 to extend a machining time (that is, a preset stop time of the tip of the rotary tool 38 in the insertion position). On the contrary, in the case where the temperature is increased sooner than being planned, feedback control in which the machining time is shortened and the machining is finished is executed.

Because the material temperature is correlated with the machining time, it is recommended in the friction point joining device 1 according to the invention that the control section 2 monitors the machining time at the same time as monitoring the temperature. In addition, it is assumed that joining failure occurs when the machining time is short, and it is assumed that a certain type of abnormality occurs to a base material when the machining time is long. Accordingly, in a case of abnormality in the machining time in the friction point joining device 1 according to the invention, it is further preferred that the control section 2 has a function of stopping the friction point joining device 1. It should be noted that it is common for this type of the conventional friction point joining device that the machining condition is experimentally computed, applied pressure, a rotational speed of the rotary tool, and the insertion position of the rotary tool are set, and torque during the machining and the machining time are determined case by case.

The friction point joining is performed by using the friction point joining device 1 according to the invention and maintaining the temperature of the boundary surface, which is the joint section between the aluminum material 3 and the galvanized steel sheet 4, to be set within a temperature range of 320° C. to 350° C. In this way, the galvanized layer of the galvanized steel sheet 4 is melted and liquefied only by the frictional heat. Together with a plastic flow of the aluminum material 3 that occurs simultaneously, the galvanized layer, which is melted and liquefied, is pushed to an outer side of the rotary tool 38. In this way, oxide films that are respectively formed on surfaces of both of the aluminum material 3 and the galvanized steel sheet 4 are damaged and diffused, and the joint section becomes a joint section of new surfaces. In addition, an intermetallic compound (Fe—Al) is formed in the joint section. Thereby, high joint strength is secured.

By the way, when the temperature of the aluminum material is increased to a temperature near a melting point 420° C. of zinc only by the friction heat as in a conventional method, such a phenomenon occurs that deformation resistance of aluminum becomes too low and thus a material flow does not occur. In this case, aluminum does not flow, and, in conjunction with this, zinc does not flow, either, and stays in a same position. Accordingly, unlike the method according to the invention, a phenomenon in which the oxide films on the surfaces of both of the aluminum material 3 and the galvanized steel sheet 4 flow to the outer side does not occur. As a result, such a phenomenon that the new surfaces are joined does not occur, either. Thus, the high joint strength is not obtained.

Next, a description will be made on the friction point joining processing that was actually performed by the inventors by using the friction point joining device 1 described on the basis of FIG. 1. As the aluminum material 3, 6000-series aluminum in a plate thickness of 1.0 mm was used. As the galvanized steel sheet 4, an alloyed hot-dip galvanized steel sheet with tensile strength of 280 MPa class in a plate thickness of 0.8 mm was used. The processing was performed with the applied pressure: 3000 N, a rotational speed of the rotary tool 38: 2000 rpm, and the machining time: 1.5 to 2.0 seconds, and the position of the tip of the rotary tool 38 was controlled to be set within the range of 0.1 to 0.3 mm on the aluminum material 3 side from a joint boundary surface between the aluminum material 3 and the galvanized steel sheet 4.

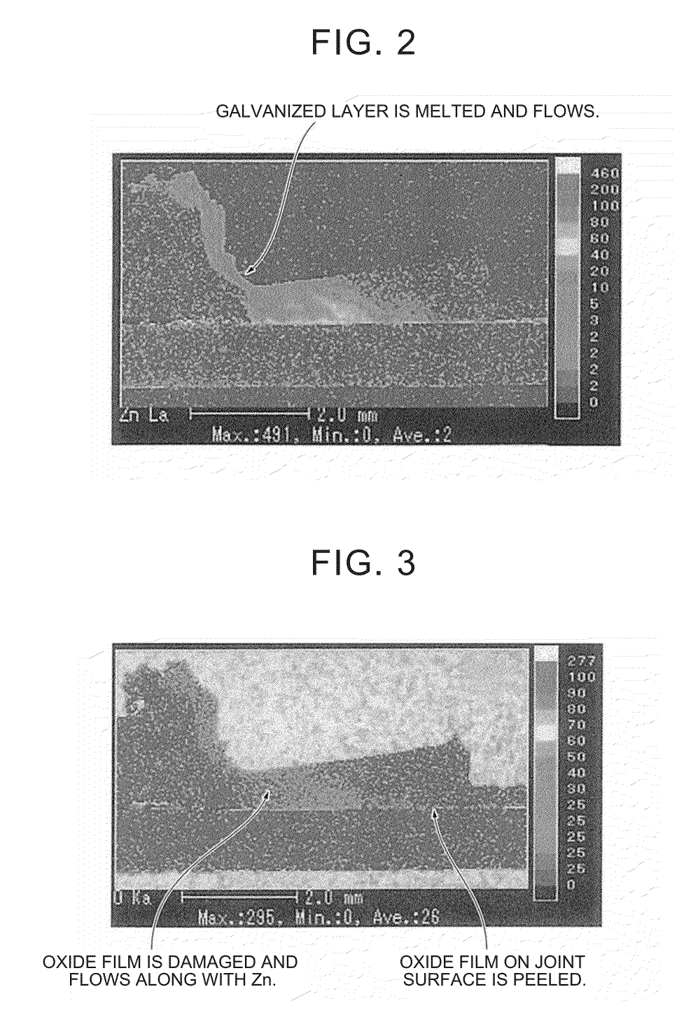

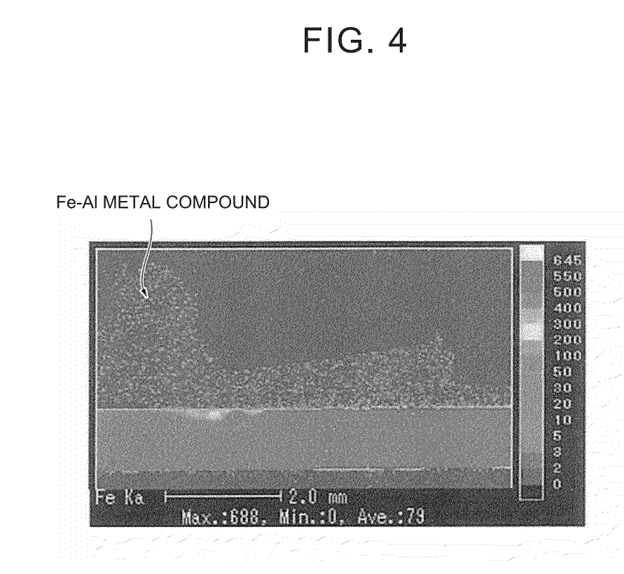

When a boundary temperature between the aluminum material 3 and the galvanized steel sheet 4 became 320° C. to 350° C. by the frictional heat that was associated with rotation of the rotary tool 38, the galvanized layer of the galvanized steel sheet 4 was melted, was liquefied, and flowed. An EPMA analysis result in the state is shown in FIG. 2. In addition, at the same time as liquefaction, the oxide films on surfaces of the base materials (both of the aluminum material 3 and the galvanized steel sheet 4) were damaged. Accordingly, when the galvanized layer was diffused along with the plastic flow of aluminum, both of the oxide layers were diffused, and the boundary surface became a new surface. The EPMA analysis result in the state is shown in FIG. 3. As the EPMA analysis result of the joint boundary surface is shown in FIG. 4, the boundary surface became the new surface. Accordingly, the new surfaces were joined while a thin metal compound (Fe—Al) was generated on the boundary surface, and an oxide compound for lowering the joint strength was not generated at this time. Thus, the rigid joint strength was obtained.

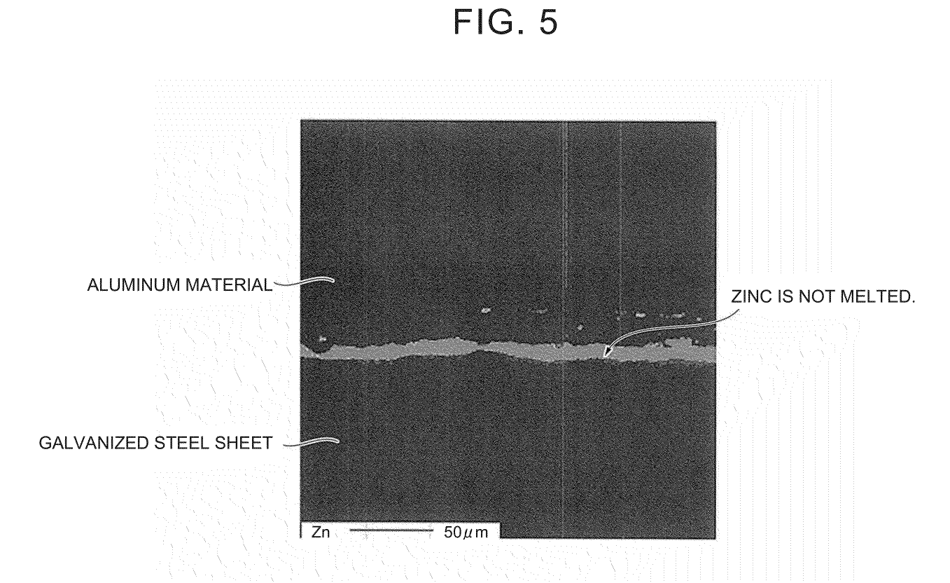

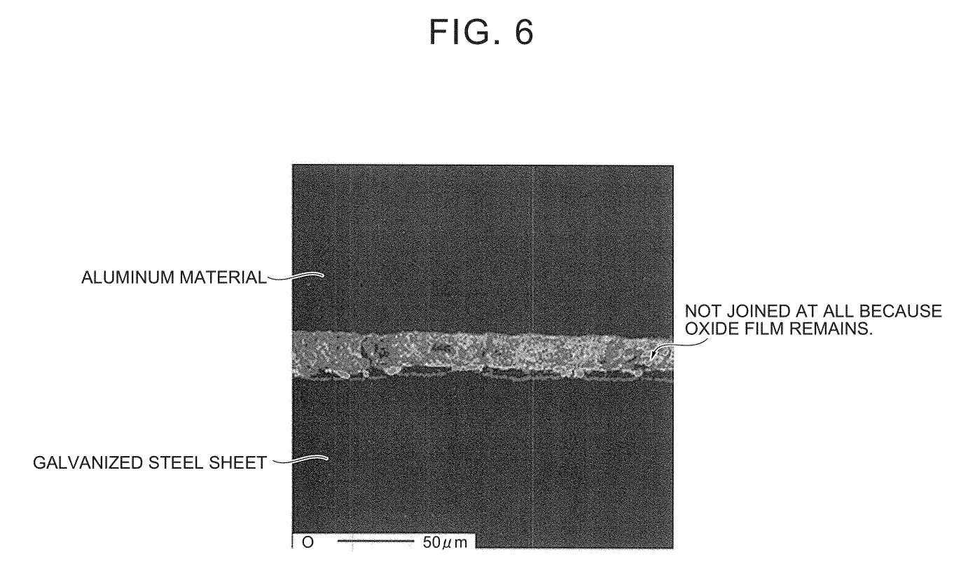

As a comparison, the processing was performed by changing the machining condition. The result is shown in FIG. 5 and FIG. 6. FIG. 5 shows a case where the machining condition was set with the machining time being within 1.0 second. As shown in the EPMA analysis result in FIG. 5, due to a lack of a heat generation amount, the galvanized layer was not melted in this condition. Thus, the high joint strength was not obtained. FIG. 6 shows a case where the machining condition was set with the tool insertion position being a position of +0.4 mm. As shown in the EPMA analysis result in FIG. 6, the generated heat did not reach the galvanized layer, and the oxide layer remained on the joint boundary surface in this condition. Thus, a sufficient joint state was not obtained.

By conducting a number of experimental studies to solve the above problem, the inventors have found out that, in the case where a temperature of the joint boundary surface between the aluminum material and the galvanized steel sheet is increased to a required temperature and the galvanized layer of the galvanized steel sheet is thereby melted and liquefied when the aluminum material and the galvanized steel sheet are joined at a friction point, the oxide films that are present on the surfaces of both of the aluminum material and the galvanized steel sheet as the base materials are damaged at the same time as liquefaction even without processing for melting and smoothing the surfaces by laser heating, both of the oxide films are diffused when the galvanized layer flows, the joint boundary surface becomes the new surface, the surfaces are joined while the thin intermetallic compound (Fe—Al) is generated on the joint boundary surface due to the new surface, and thereby the high joint strength is obtained. The inventors have also found out that, in order to perform the processing as described above, it is essential to accurately control a distance between a position of the tip of the rotary tool and the joint boundary surface between the aluminum material and the galvanized steel sheet to be set within a required distance range and to control the temperature of the joint boundary surface to be set within a required temperature range in the friction point joining device.

Based on the above findings, an aspect of the invention can provide the friction point joining device and the friction point joining method in which the joint strength can be high for friction point joining between the aluminum material and the galvanized steel sheet without forming a Zn—Fe alloy plated layer and performing processing for melting and smoothing a surface thereof by laser heating and that can thereby simplify the entire device.

The friction point joining device according to the aspect of the invention includes a feedback device that executes feedback control of the servo motor on the basis of the temperature information of the joint section of the stacking body and the temperature information of the rotary tool. Accordingly, the distance between the tip of the rotary tool and the joint section between the aluminum material and the galvanized steel sheet can be controlled to be set within the required range, and the temperature of the joint section can be controlled to be set within the required temperature range. When the aluminum material and the galvanized steel sheet are joined at the friction point by using the friction point joining device according to the aspect of the invention, a friction point joint product with the high joint strength can be obtained. As targets of the feedback control, a rotational speed of the servo motor, the applied pressure, the machining time, and the like are raised.

A heat input amount is set such that the temperature of the joint section becomes 320 to 350° C., and the processing is performed at such a rotational speed of the servo motor, an applied pressure, and a machining time that the set heat input amount is obtained. Meanwhile, the temperature of the joint section cannot directly be measured. However, due to a high heat transfer coefficient of an aluminum sheet, it is estimated whether the temperature of the joint section reaches the target temperature by measuring temperatures of a position where the rotary tool comes into contact with the aluminum sheet and of a position in the vicinity of the position. In the case where the measured temperature is too high or low with respect to the target temperature, the feedback control is executed, and various conditions are changed such that the temperature of the joint section becomes the target temperature.

In addition, by using the friction point joining method according to the aspect of the invention, the friction point joint product of the aluminum material and the galvanized steel sheet with the high joint strength can be obtained.

According to what has been described so far, the new friction point joining device and the new friction point joining method by which the friction point joint product of the aluminum material and the galvanized steel sheet with the high joint strength can be manufactured are provided.

What is claimed is:

1. A friction point joining device for joining an aluminum material and a galvanized steel sheet, the friction point joining device comprising:
a rotary tool abutting against the aluminum material side of a stacking body of the aluminum material and the galvanized steel sheet;
a servo motor for causing the rotary tool to rotate;
a tool temperature measuring instrument for measuring a temperature of the rotary tool;
a material temperature measuring instrument for measuring a temperature of a joint section between the aluminum material and the galvanized steel sheet; and
a feedback device configured to execute feedback control of the servo motor on the basis of temperature information obtained from the tool temperature measuring instrument and the material temperature measuring instrument.

2. The friction point joining device according to claim 1 wherein
the feedback device is configured to control the servo motor such that the temperature of the joint section becomes 320 to 350° C.

3. A friction point joining method of a friction point joining device for joining an aluminum material and a galvanized steel sheet at a friction point, the friction point joining device including a rotary tool, the rotary tool abutting against the aluminum material side of a stacking body of the aluminum material and the galvanized steel sheet; the friction point joining method characterized by comprising:
forming a new surface in a joint section between the aluminum material and the galvanized steel sheet by setting a temperature of the joint section to be within a range of 320° C. to 350° C. by frictional heat that is associated with rotation of the rotary tool and performing friction point joining while generating an intermetallic compound of Fe and Al in the joint section.

4. The friction point joining method according to claim 3 wherein the friction point joining is performed in such a state that a distance between a surface of the galvanized steel sheet in the joint section and a tip of the rotary tool is maintained to be within a range of 0.1 mm to 0.3 mm on the aluminum material side.
